(19) United States
(12) Patent Application Publication
(10) Pub. No.: US 2020/0320370 A1
(43) Pub. Date: Oct. 8, 2020

(54) SNIPPET EXTRACTOR: RECURRENT NEURAL NETWORKS FOR TEXT SUMMARIZATION AT INDUSTRY SCALE

(71) Applicant: eBay Inc., San Jose, CA (US)

(72) Inventors: Chandra Prakash Khatri, San Jose, CA (US); Nish Parikh, Fremont, CA (US); Sameep Navin Solanki, San Jose, CA (US); Justin Nicholas House, San Jose, CA (US); Gyanit Singh, Fremont, CA (US)

(21) Appl. No.: 16/857,958

(22) Filed: Apr. 24, 2020

Related U.S. Application Data
(63) Continuation of application No. 15/267,346, filed on Sep. 16, 2016, now abandoned.
(60) Provisional application No. 62/281,307, filed on Jan. 21, 2016.

(51) Int. Cl. G06N 3/04; G06F 16/34

(52) U.S. Cl. CPC G06N 3/0445; G06F 16/345

(57) ABSTRACT

Systems, methods and media are provided for training a snippet extractor to create snippets based on information extracted from published descriptions. In one example, a computer-implemented method includes creating, based on a non-RNN (Recurrent Neural Network) extraction technique performed on the published descriptions, a plurality of base models, each base model including one or more sample description summaries; evaluating the base models using an evaluation technique; selecting an optimum base model; developing a classification model using RNN extraction, the classification model based on description summaries contained in the optimum base model; and using the classification model to train the snippet extractor by machine learning.

### CROSS-REFERENCES

This application is a continuation of U.S. patent application Ser. No. 15/267,346 to Khatri et al., entitled “Snippet Extractor: Recurrent Neural Networks for Text Summarization at Industry Scale,” filed Sep. 16, 2016; which claims the benefit of priority of U.S. Provisional Patent Application No. 62/281,307 to Khatri et al., entitled “Snippet Extractor: Experimenting Recurrent Neural Networks for Text Summarization at Industry Scale,” filed on Jan. 21, 2016; each of which is hereby incorporated by reference herein in its entirety.

### BACKGROUND

In this era of mobile computing, in which screen sizes for the presentation of information are becoming smaller while data is growing exponentially, accurate text summarization is becoming increasingly relevant for search engines, e-Commerce websites, news websites, social-networking websites, and so forth.

### BRIEF SUMMARY

In the present subject matter, summaries (snippets) are generated for published items using descriptions provided by listers or publishers of that content. A snippet can be a small piece of information or brief extract about a published item. In search engines for example, search snippets include summaries of web pages that help users preview content and decide if they want to investigate further.

One objective of the present disclosure is to generate snippets which can be helpful for a user to assess quickly whether he or she is interested in the item. In an e-commerce application (and the present disclosure is not limited to this), this approach can lead to faster purchase decisions and higher conversion rates for a given retailer or marketplace host. In one study, comparative analysis of various snippet generation techniques was performed. In some examples, Recurrent Neural Networks (RNNs) were also used for extraction and abstraction-based summarizations. The training data for RNNs was obtained from the summaries generated using a “topic-signature”-based information retrieval approach and also a so-called “golden dataset” obtained from human curators. Examples of the golden dataset are discussed further below. Topic signatures are the set of words highly descriptive of an input document. For some items, topic signatures correspond to search queries, item aspects, title words, item category words and corresponding synonyms.

In one aspect, it was shown that topic signature-based summarization is very effective and leads to significant user engagement (for example, in terms of viewing or purchasing) and conversions for e-commerce items. In another aspect, summaries obtained from this technique were used for building highly scalable language models. It was also determined that there are better techniques than topic signature-based summarization in some examples. This finding can lead to even more user engagement and better quality snippet creation.

In other examples, an evaluation of various summarization techniques was performed with respect to two kinds of standard: (i) summaries obtained using topic signature-based information retrieval approach and (ii) human-curated Summary Content Units (SCUs). Human-curated summaries were used for micro-level evaluation while the summaries obtained from the topic signature-based approach were used for macro-level evaluation.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating a networked system, according to some example embodiments.

FIG. 2 is a block diagram showing the architectural details of a publication system, according to some example embodiments.

FIG. 3 is a block diagram illustrating a representative software architecture software architecture, which may be used in conjunction with various hardware architectures herein described.

FIG. 4 is a block diagram illustrating components of a machine, according to some example embodiments, able to read instructions from a machine-readable medium (e.g., a machine-readable storage medium) and perform any one or more of the methodologies discussed herein.

FIGS. 5-12 depict example algorithms and various aspects of the current disclosure, in accordance with example embodiments.

### DETAILED DESCRIPTION

“CARRIER SIGNAL” in this context refers to any intangible medium that is capable of storing, encoding, or carrying instructions for execution by the machine, and includes digital or analog communications signals or other intangible media to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra-books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein.

Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations.

Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“MACHINE-READABLE MEDIUM” in this context refers to a component, device or other tangible media able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2016, eBay Inc., All Rights Reserved.

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

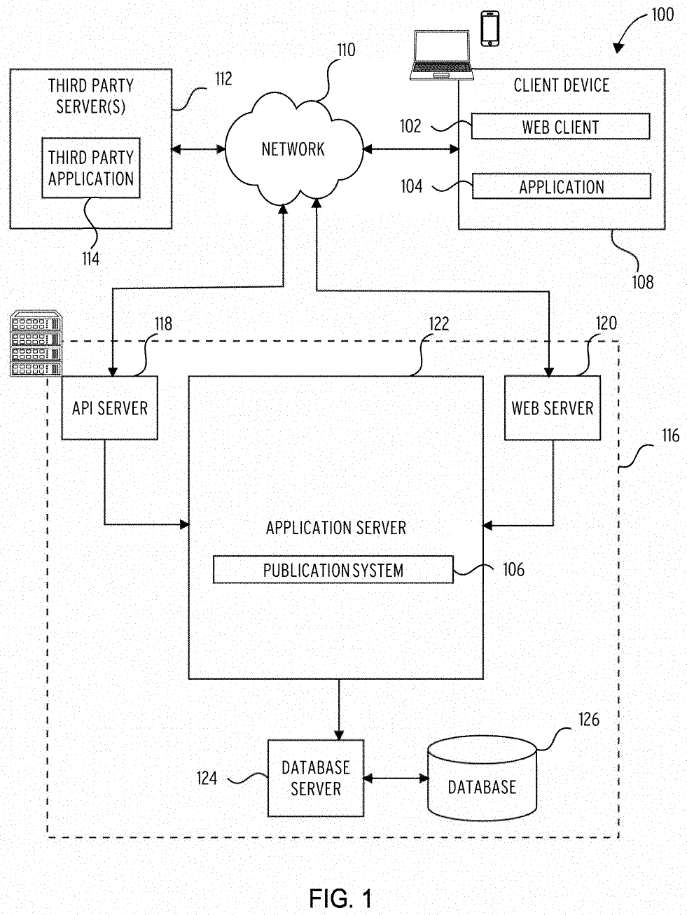

With reference to FIG. 1, an example embodiment of a high-level SaaS network architecture 100 is shown. A networked system 116 provides server-side functionality via a network 110 (e.g., the Internet or wide area network (WAN)) to a client device 108. A web client 102 and a programmatic client, in the example form of an application 104, are hosted and execute on the client device 108. The networked system 116 includes an application server 122, which in turn hosts a publication system 106 that provides a number of functions and services to the application 104. The application 104 also provides a number of interfaces described herein, which present output of the tracking and analysis operations to a user of the client device 108.

The client device 108 enables a user to access and interact with the networked system 116. For instance, the user provides input (e.g., touch screen input or alphanumeric input) to the client device 108, and the input is communicated to the networked system 116 via the network 110. In this instance, the networked system 116, in response to receiving the input from the user, communicates information back to the client device 108 via the network 110 to be presented to the user.

An Application Program Interface (API) server 118 and a web server 120 are coupled to, and provide programmatic and web interfaces respectively to, the application server 122. The application server 122 hosts a publication system 106, which includes components or applications. The application server 122 is, in turn, shown to be coupled to a database server 124 that facilitates access to information storage repositories (e.g., a database 126). In an example embodiment, the database 126 includes storage devices that store information accessed and generated by the publication system 106.

Additionally, a third-party application 114, executing on a third-party server 112, is shown as having programmatic access to the networked system 116 via the programmatic interface provided by the Application Program Interface (API) server 118. For example, the third-party application 114, using information retrieved from the networked system 116, may support one or more features or functions on a web site hosted by the third party.

Turning now specifically to the applications hosted by the client device 108, the web client 102 may access the various systems (e.g., publication system 106) via the web interface supported by the web server 120. Similarly, the application 104 (e.g., an “app”) accesses the various services and functions provided by the publication system 106 via the programmatic interface provided by the Application Program Interface (API) server 118. The application 104 may, for example, be an “app” executing on a client device 108, such as an iOS or Android OS application to enable the user to access and input data on the networked system 116 in an off-line manner, and to perform batch-mode communications between the programmatic client application 104 and the networked system 116.

Further, while the SaaS network architecture 100 shown in FIG. 1 employs a client-server architecture, the present inventive subject matter is of course not limited to such an architecture, and could equally well find application in a distributed, or peer-to-peer, architecture system, for example. The publication system 106 could also be implemented as a standalone software program, which do not necessarily have networking capabilities.

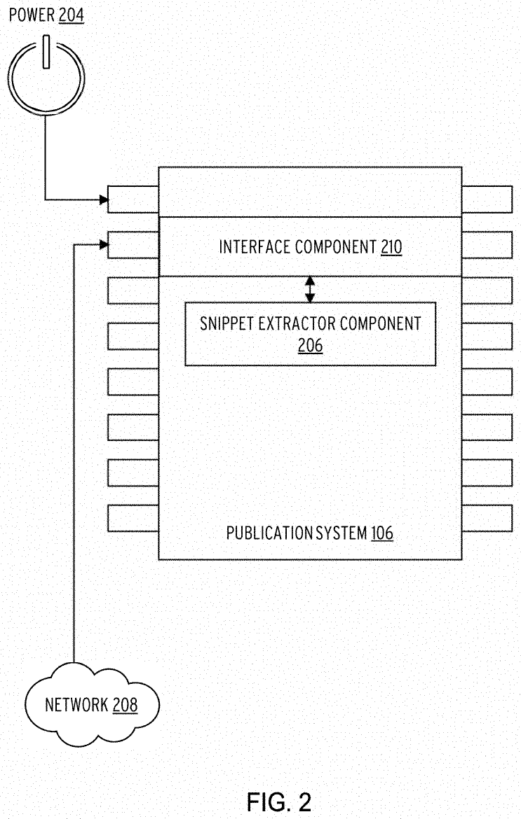

FIG. 2 is a block diagram showing the architectural details of a publication system 106, according to some example embodiments. Specifically, the publication system 106 is shown to include an interface component 210 by which the publication system 106 communicates (e.g., over the network 208) with other systems within the SaaS network architecture 100. The interface component 210 is collectively coupled to a snippet extractor component 206 that operates to perform the industry-level text summarization methods described herein. The snippet extractor component 206 may include other components or interact with other components in the publication system 106.

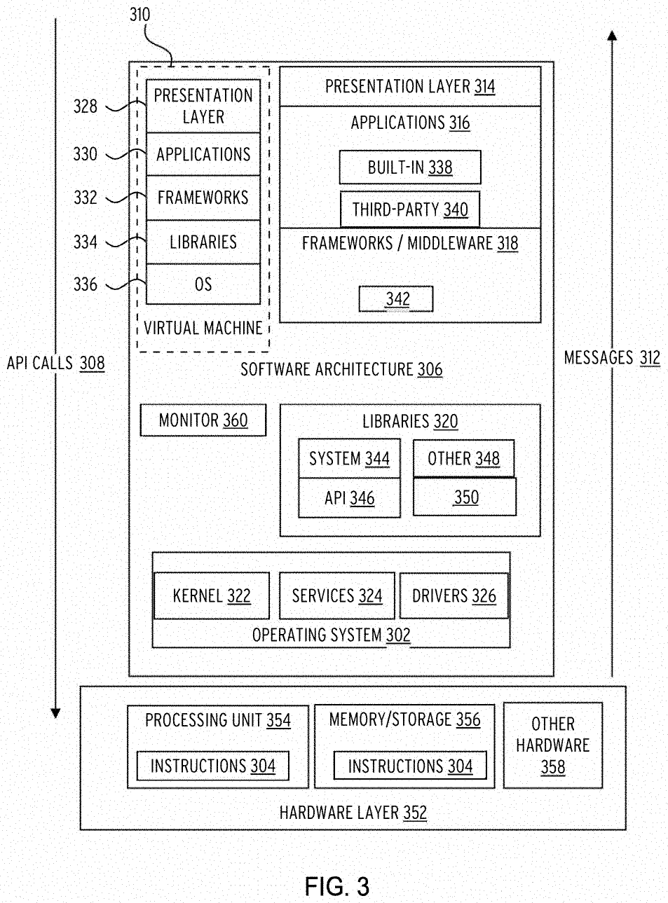

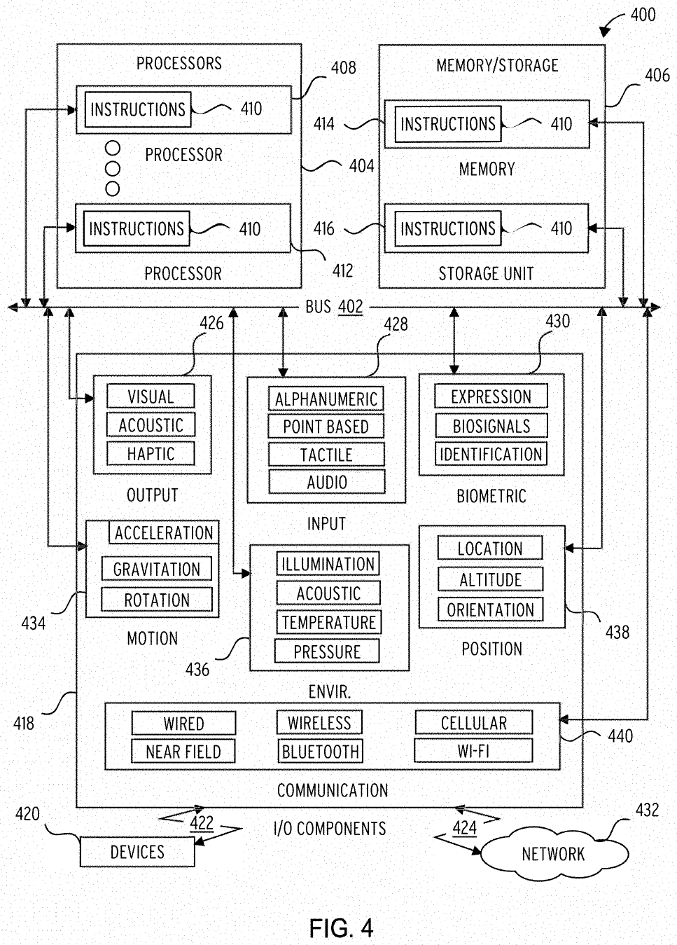

FIG. 3 is a block diagram illustrating an example software architecture 306, which may be used in conjunction with various hardware architectures herein described. FIG. 3 is a non-limiting example of a software architecture and it will be appreciated that many other architectures may be implemented to facilitate the functionality described herein. The software architecture 306 may execute on hardware such as machine 400 of FIG. 4 that includes, among other things, processors 404, memory 414, and I/O components 418. A representative hardware layer 352 is illustrated and can represent, for example, the machine 400 of FIG. 4. The representative hardware layer 352 includes a processing unit 354 having associated executable instructions 304. Executable instructions 304 represent the executable instructions of the software architecture 306, including implementation of the methods, components and so forth described herein. The hardware layer 352 also includes memory and/or storage modules as memory/storage 356, which also have executable instructions 304. The hardware layer 352 may also comprise other hardware 358.

In the example architecture of FIG. 3, the software architecture 306 may be conceptualized as a stack of layers where each layer provides particular functionality. For example, the software architecture 306 may include layers such as an operating system 302, libraries 320, applications 316 and a presentation layer 314. Operationally, the applications 316 and/or other components within the layers may invoke application programming interface (API) calls 308 through the software stack and receive messages 312 in response to the API calls 308. The layers illustrated are representative in nature and not all software architectures have all layers. For example, some mobile or special purpose operating systems may not provide a frameworks/middleware 318, while others may provide such a layer. Other software architectures may include additional or different layers.

The operating system 302 may manage hardware resources and provide common services. The operating system 302 may include, for example, a kernel 322, services 324 and drivers 326. The kernel 322 may act as an abstraction layer between the hardware and the other software layers. For example, the kernel 322 may be responsible for memory management, processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than to interface directly with the underlying operating system 302 functionality (e.g., kernel 322, services 324 and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/modules.

The frameworks/middleware 318 (also sometimes referred to as middleware) provide a higher-level common infrastructure that may be used by the applications 316 and/or other software components/modules. For example, the frameworks/middleware 318 may provide various graphic user interface (GUI) functions, high-level resource management, high-level location services, and so forth. The frameworks/middleware 318 may provide a broad spectrum of other APIs that may be utilized by the applications 316 and/or other software components/modules, some of which may be specific to a particular operating system or platform.

The applications 316 include built-in applications 338 and/or third-party applications 340. Examples of representative built-in applications 338 may include, but are not limited to, a contacts application, a browser application, a book reader application, a location application, a media application, a messaging application, and/or a game application. Third-party applications 340 may include any an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 340 may invoke the API calls 308 provided by the mobile operating system (such as operating system 302) to facilitate functionality described herein.

The applications 316 may use built-in operating system functions (e.g., kernel 322, services 324 and/or drivers 326), libraries 320, and frameworks/middleware 318 to create user interfaces to interact with users of the system. Alternatively, or additionally, in some systems, interactions with a user may occur through a presentation layer, such as presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 400 of FIG. 4, for example). The virtual machine 310 is hosted by a host operating system (operating system (OS) 336 in FIG. 3) and typically, although not always, has a virtual machine monitor 360, which manages the operation of the virtual machine 310 as well as the interface with the host operating system (i.e., operating system 302). A software architecture executes within the virtual machine 310 such as an operating system (OS) 336, libraries 334, frameworks 332, applications 330 and/or presentation layer 328. These layers of software architecture executing within the virtual machine 310 can be the same as corresponding layers previously described or may be different.

FIG. 4 is a block diagram illustrating components of a machine 400, according to some example embodiments, able to read instructions from a machine-readable medium (e.g., a machine-readable storage medium) and perform any one or more of the methodologies discussed herein. Specifically, FIG. 4 shows a diagrammatic representation of the machine 400 in the example form of a computer system, within which instructions 410 (e.g., software, a program, an application, an applet, an app, or other executable code) for causing the machine 400 to perform any one or more of the methodologies discussed herein may be executed. As such, the instructions 410 may be used to implement modules or components described herein. The instructions 410 transform the general, non-programmed machine into a particular machine programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 410, sequentially or otherwise, that specify actions to be taken by machine 400. Further, while only a single machine 400 is illustrated, the term “machine” shall also be taken to include a collection of machines that individually or jointly execute the instructions 410 to perform any one or more of the methodologies discussed herein.

The machine 400 may include processors 404, memory/storage 406, and I/O components 418, which may be configured to communicate with each other such as via a bus 402. The memory/storage 406 may include a memory 414, such as a main memory, or other memory storage, and a storage unit 416, both accessible to the processors 404 such as via the bus 402. The storage unit 416 and memory 414 store the instructions 410 embodying any one or more of the methodologies or functions described herein. The instructions 410 may also reside, completely or partially, within the memory 414, within the storage unit 416, within at least one of the processors 404 (e.g., within the processor's cache memory), or any suitable combination thereof, during execution thereof by the machine 400. Accordingly, the memory 414, the storage unit 416, and the memory of processors 404 are examples of machine-readable media.

The I/O components 418 may include a wide variety of components to receive input, provide output, produce output, transmit information, exchange information, capture measurements, and so on. The specific I/O components 418 that are included in a particular machine will depend on the type of machine. For example, portable machines such as mobile phones will likely include a touch input device or other such input mechanisms, while a headless server machine will likely not include such a touch input device. It will be appreciated that the I/O components 418 may include many other components that are not shown in FIG. 4. The I/O components 418 are grouped according to functionality merely for simplifying the following discussion and the grouping is in no way limiting. In various example embodiments, the I/O components 418 may include output components 426 and input components 428. The output components 426 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 428 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 418 may include biometric components 430, motion components 434, environment components 436, or position components 438, among a wide array of other components. For example, the biometric components 430 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 434 may include acceleration sensor components (e.g., accelerometer), gravitation sensor components, rotation sensor components (e.g., gyroscope), and so forth. The environment components 436 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 438 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 418 may include communication components 440 operable to couple the machine 400 to a network 432 or devices 420 via coupling 424 and coupling 422 respectively. For example, the communication components 440 may include a network interface component or other suitable device to interface with the network 432. In further examples, communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 420 may be another machine or any of a wide variety of peripheral devices (e.g., a peripheral device coupled via a Universal Serial Bus (USB)).

Moreover, the communication components 440 may detect identifiers or include components operable to detect identifiers. For example, the communication components 440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 440, such as location via Internet Protocol (IP) geo-location, location via Wi-Fi® signal triangulation, location via detecting a NFC beacon signal that may indicate a particular location, and so forth.

As mentioned briefly above, document summarization finds application in almost all domains of the Internet. For example, search engines provide query and context-specific summary snippets as a part of search experience, news websites use summaries to brief the articles, social media use them for content targeting while e-commerce websites use summaries for better browsing experience through item or product highlights. In one example, the present disclosure seeks to extract content from item descriptions to assist buyers in deciding whether they are interested in the listing or not without reading a full item description. Extracted key information can include, for example, product specifics, comments such as “used for two weeks”, “contains scratches” and so forth. Extracted information, when selected appropriately, can minimize spam and seller-specific information, and decrease redundancy by avoiding duplicate information such as shipping and return information.

Snippets can be drivers of user engagement and can be useful for minimizing the time required for making the right or most appropriate purchase, providing clues to a fuller item description, making item comparison, and in defining user interfaces for mobile sites and native applications in view of limited display space, which makes it technically difficult to show entire items descriptions without straining the eye of the reader or generating unhelpful clutter. Snippet optimization can provide significant technical and business benefits. In one example, a snippet on VI generated a 2% GMB lift (using a description one click away test: with and without a snippet), and a 3.5% lift in SEO metadata on incoming SEO CTR. In other words, when snippets of the present disclosure were added to meta-descriptions for search engines (like Google, Bing or others) to crawl (i.e. “hit”), this led to a 3.5% lift in incoming sessions from search engines. That is, when deployed, snippets of the present disclosure attract 3.5% more customers from search engines than without snippets in meta-descriptions.

From a general publisher, or more specific e-commerce, point of view, given the same amount of time, a user can quickly assess more numbers of items by using item summaries or snippets as opposed to complete item descriptions. Therefore, keeping time as a constraint, item snippets can lead to higher user engagement. This also provides a better browsing experience for users, which is one of the primary objectives of many publishers of content. Furthermore, as the traffic on mobile sites and applications increases, item snippets become much more relevant. But technical problems arise, such as limited screen size. Moreover, mobile applications typically use a native environment and are therefore bound by HTML restrictions. A native environment is one of the primary forms in which sellers provide item descriptions, for example. Therefore, due to display space limits for mobile applications and mobile sites, it is even more important from a design point of view to be able to show relevant item snippets or “blobs” than conventional HTML elements.

Technical challenges abound in using existing rules-based summarization techniques, such as topic signature techniques. These challenges include, for example: evaluation (human evaluation is not possible at scale), language-specific constraints (for example, compound splitter, word frequency, dictionary, blacklists), generality (rules-based approach does not generalize well; for example, a phrase such as “This item has a scratch and has been used for two weeks” provides no topic words), scalable system (the summarization rules are static and it is hard to capture seasonal variations), context, for example extending to SRP, PRP, and reviews (similar summaries for all these different pages: SRP, PRP, reviews). Further, it is difficult to capture any latent information when using existing rules-based summarization techniques (for example, information not available in topic signature words).

Some solutions disclosed herein are based on Machine Learning (ML) Natural Language Processing (NLP). Example technical solutions can include:

A) Classification Using Existing Snippets (using Naïve Bayes, SVM, or Recurrent Neural Network Classification with a vector embedding size of 200, by way of open example) through the approach of supervised learning.

B) Information Retrieval-Based Approaches (using for example TextRank: PageRank+Edge: # of common words, or LexRank: PageRank+Edge, using cosine similarity of tf-idf vectors, or a Latent Semantic Analysis in a Topic-based approach), which are closer to unsupervised learning approaches.

C) Abstraction-Based RNN Abstraction (for example, predicting a summary given a description, or a continuous bag of words (CBOW) model in which a word is predicted given context, or adopting a learning language model using LS™-based sequence learning techniques).

To this end, various studies were performed, and enhanced summarization techniques identified. In one study of the present disclosure, an exhaustive comparative analysis of various existing summarization techniques was performed for identified listed items. Furthermore, summarization using Recurrent Neural Networks (RNNs) and Convolutional Neural Network (CNN) was explored. Most of the summarization techniques included either extraction or abstraction techniques. In one extraction technique, sentences and objects were extracted without modifying the objects themselves. This was obtained by key-phrase or ad-hoc sentence extraction, keeping the sentences intact. On the other hand, one abstraction technique involved paraphrasing context-aware sentences after understanding the applicable language.

Several summarization techniques have been explored over the past decades and some of the most popular approaches are:

1. Surface-level approaches, which consider the presence of title words and cue-words (e.g. “important”, “best” etc.) within sentences, term frequencies, and position of sentences for selecting the relevant sentences.

2. Corpus-based approaches, which leverage the structure and distribution of words within an internal corpus or external corpus such as WordNet for summarization. It includes in some examples term frequency-inverse document frequency (tf-idf), concept-relevance from WordNet, and usage of Bayesian classifiers to rank the sentences or paragraphs for summarization.

3. Cohesion-based approaches, which seek to capture cohesive relations between concepts within text such as antonyms, repetitions, synonyms, etc., using Lexical Chains or anaphoric expressions (i.e., words which refer back to previously expressed words or phrases, e.g., pronouns: “he”, “she” etc.). These approaches are useful in retaining the context of an extraction and makes the summary more readable.

4. Graph-based approaches, which are some of the most popular text summarization techniques. Each sentence in a given text is represented as a vertex and a graph is constructed around all the sentences, wherein the edges correspond to inter-connections between the sentences. The edges represent a form of semantic similarity or content overlap within the sentences. LexRank and TextRank, for example, use two such techniques. LexRank uses cosine similarity of tf-idf vectors, while TextRank uses number of common words between two sentences normalized by sentence lengths.

5. Machine learning-based approaches, which have been described, for example, in a paper published by the CMU.

6. Abstractive summarization techniques, which are less prevalent in the literature than the extractive ones. This technique is harder because it involves re-writing text sentences and requires natural language generation techniques. The two common abstraction techniques are structured and semantic techniques, both of which are mostly either graph/tree-based or ontology and rule (e.g., template) based. Due to certain complexity constraints, research to-date has focused primarily on extractive methods, but due to advancements in Natural Language Generation techniques using Recurrent Neural Networks, this field is increasing. This is where some examples of the present subject matter lie.

In another study of the present disclosure, an industry-level experiment was set-up wherein thousands of item summaries from various categories (electronics, fashion, home & garden, automobiles, etc.) were generated using existing state-of-the-art technologies and were compared with newly proposed RNN-based summarization techniques described further below. In one example, a body of published listings included around one billion items ranging from thousands of categories, and it was not practically feasible to evaluate the output from the techniques proposed herein with human curated data. Therefore, a unique methodology for industry-scale evaluation is herein described, wherein some of the existing and adopted summarization techniques are chosen as base models and are validated with limited human curated summaries. Once validated, their output is then used for automated evaluation of summaries generated using RNN-based techniques. The selection of base models is therefore performed using human curated “gold standards” to generate a “golden dataset” as referred to herein.

In another setup, a golden dataset was created which included descriptions and summaries generated by humans. The dataset was used for training different classification or abstraction-based techniques. Some part of it (in one example, 80%) was used for training and the remaining 20% of such data was used for testing different models. For example, RNN-Extraction, SVM, Naïve Bayes used 80% for training, while other information extraction-based unsupervised techniques such as LexRank, TextRank, Topic Signature, LSA do not require training. The same 20% of the dataset was used to test the output of the later techniques as well. Since the “ground truth” or the “best” summaries obtained from humans (i.e., the golden dataset) was already present, these base summaries were used to evaluate all the summarization techniques mentioned herein.

In one example, the generated summaries were bounded by length, for example not exceeding four sentences in length and/or being less than two hundred characters, and without including a standard compression ratio. Furthermore, in one example a retention ratio was calculated by using so-called topic signature words, wherein a ratio of coverage of topic signature words was calculated before and after summarization.

In the sections that follow, certain examples are provided. Initially, a background is given of existing summarization techniques and their implementation in leading to the selection of a base model for larger scale evaluation. Further sections describe the so-called “snippet extractor” (for example, snippet extractor component 206 in FIG. 2), proposing RNN as a summarization technique. Subsequently, a detailed evaluation of both the proposed and existing summarization techniques is provided. Further sections report on results and findings while final section compiles conclusions and technical solutions.

The creation of base models using existing summarization techniques is now discussed. In one example study, both extraction and abstraction techniques were explored. Since the experiment was set up at an industry level, there was a need to create some base models for evaluation of large scale experiments. Evaluation with respect to human-judged “gold standards” merely provides some pointers in the right direction. However, obtaining hundreds of thousands of summaries through human curation is a time consuming task and is practically not feasible. Therefore, in one study, various existing state-of-the-art summarization techniques were explored, and some of them were chosen as base models to evaluate the summaries obtained from the RNN-based extraction and abstraction techniques. The base models were chosen with reference to human curated standards designed for the experiment. The following summarization techniques were explored for the base models in current experiment:

1.1 Graph-Based

LexRank[Ref] and TextRank[Ref] are the two most popular graph-based techniques. As mentioned before, in these approaches, sentences correspond to vertices and connection between these vertices is made through a similarity function between two sentences. In the example study, both LexRank and TextRank were explored.

1.2 LSA-Based

Latent Semantic Analysis (LSA) tries to capture the relationships between terms and concepts using Singular Value Decomposition. LSA has been widely used in the text research community due to its effectiveness in capturing the main topics within the given text. Once the topics were identified, the summarization systems were ranked according to the similarity of the main topics of their summaries and their reference documents. In the example study, topics within each item description were identified using LSA, along with topic signatures that were used for ranking various sentences and obtaining text summaries.

1.3 Entities and LDA Topic Model Based

Latent Dirichlet Allocation (LDA) is one of the most popular topic modeling approaches. It is a generative approach and can be referred to as a probabilistic version of LSA. It assumes that each document is a mixture of a small number of topics and that each word's creation is attributable to one of the document's topics. Various entities and topics are obtained using LDA and are used in combination with topic signature words for ranking as performed in LSA.

1.4 Naïve Bayes Classification-Based

Naïve Bayes classifier has been widely used in machine learning-based summarization techniques, wherein a probability of each sentence as a summary sentence is calculated using some features. Naïve Bayes assumes an independence of features in the modeling. It requires summaries for training. Sentences from existing summaries are labeled as belonging to one class, while sentences which are not present in the summaries are used as another class. This makes the problem a binary classification problem. In the example study, various features were used for building the classification model, such as wrd-embeddings, tf-idf, sentence length, and so forth.

1.5 Word-Embeddings-Based Similarity

Recently, various word-embeddings-based techniques have provided remarkable results. Generally, text data is highly dimensional, when each word is considered as a feature. The objective is to map the original text, which is high dimensional, into smaller dimensional vectors. Instead of each word being a dimension, all the words are mapped to some n-dimensional vector space. This way, all the words are mapped to the same dimension vector. Similar words (both in terms of context and meaning) appear close to each other in the vector space. Given this definition, word-embeddings can be very useful for similarity tasks. The word-embeddings can also be used as features in classification-based techniques (SVM/Neural Network). Some of the most popular word-embeddings methods are Word2Vec, Glovep and Doc2Vec. In the example study, these techniques were used for evaluation and summarization tasks.

1.6 Neural Network Using Third Party Features

Neural network-based classification model for summarization has been tried in some examples using third party features. The third party features are similar to topic signature words. It has been shown that existing information in the form of topic pointers when leveraged in the form of features can lead to good results. In the example study, topic signatures were used along with Neural Network classifiers for obtaining sentences. For example, highly precise seller information, a black list, email contacts, etc., as negative classes, as well as highly precise other information such as title words, search queries and all topic signature-based sentences as a positive class, were also used as features.

1.7 Topic Signature-Based

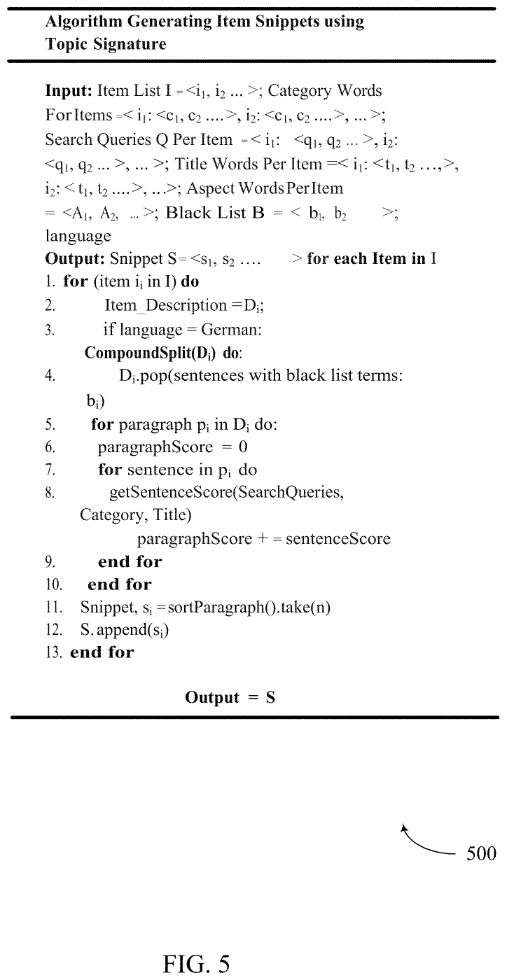

Topic signature-based summarization model leverages various document related clues. Search queries, titles, item aspects, categories and various topic words-based summaries correlate well with human summaries. One example leveraged millions of summaries for training RNN and CNN classification models. The topic signature summarization algorithm 500 for this approach is depicted in FIG. 5.

1.8 De-Duplication-Based

The idea in this approach is first to remove certain information, such as seller-specific, shipping-specific information such that only item-specific information remains. Then one keeps on de-duplicating the target sentences based on cosine similarity either using tf-idf vectors or count vectors or word embeddings until the top 3-4 sentences are left out. In this approach, each sentence in the cleaned description is compared with other sentences, and every comparison sentence is retained. The idea is to cover a maximum amount of most varied information. The results obtained from this approach are very interesting but are contextually out of order; therefore, if the summary is represented in the form of discrete information such as bullet points, then it makes much more sense. In one example, not all the secondary sentences were used as negative class, because it was possible that highly “close” sentences might also be treated as negatives. Rather, the worst-“n”, or black list/seller-specific sentences were chosen, or those sentences which did not have any of the topic signature words as a negative label.

1.9 Choosing Base Models Using “Gold Standard” Data

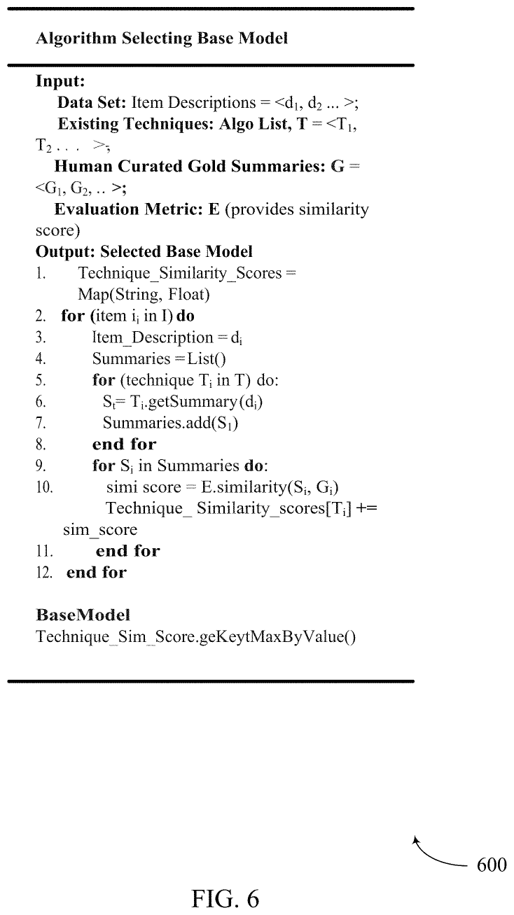

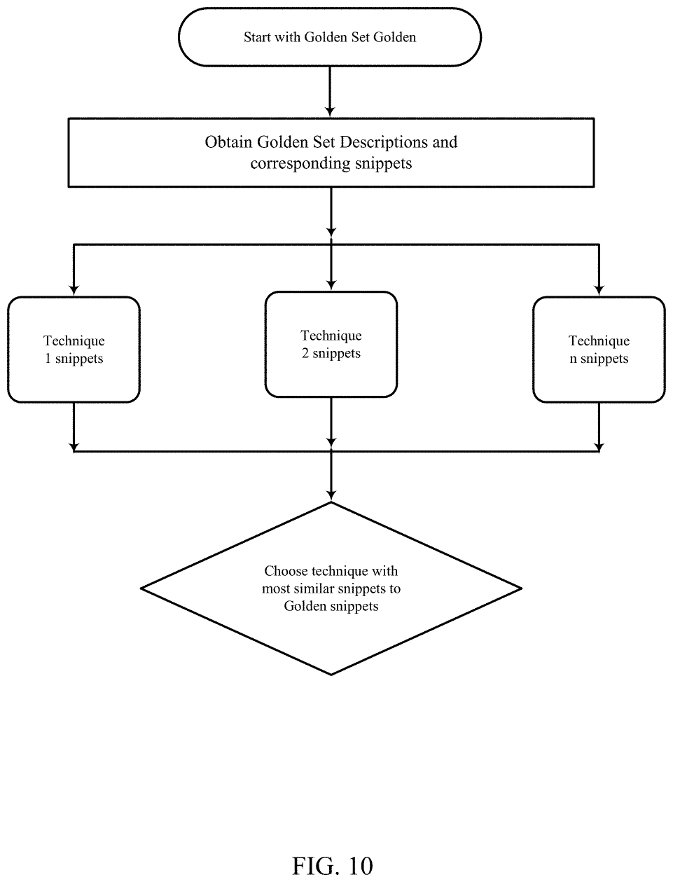

Results obtained from all the above mentioned approaches were compared against each other for selecting the desired base models. A detailed algorithm selecting base model 600 for comparing various models and selecting base models is depicted in FIG. 6. A more general flow diagram is shown in FIG. 10.

Let's say there are five different algorithms which we want to use to select the base model. The base model will be used for training more complex machine learning classification-based models such as RNN. Therefore, the base model has to be an unsupervised approach like topic signature, LSA, LexRank or TextRank. In order to choose the base model, summaries from all these techniques are compared with summaries obtained from the golden dataset. While obtaining the summaries from each technique, a similarity score with respective golden dataset summaries is stored. The technique that gives the highest aggregated similarity score when compared with the golden dataset is selected as a base model. In this example, topic signature-based summarization was the closest to the golden dataset summaries from the previously mentioned unsupervised techniques.

A snippet extractor methodology is now described. In one example, a snippet extractor is a set of algorithms that leverages RNN-based extraction and abstraction techniques. RNN is a type of neural network which is an extension to Feed Forward NN, with at least one feedback connection so that activations can flow in a loop. Furthermore, deep connections in RNN can help in learning large sequences, spatial and temporal behaviors. The feedback loop enables networks to do temporal processing and learn sequences, which can be very useful for time series and natural language tasks where the appearance of one word depends on the previous words and context in action. Furthermore, while RNNs are Turing complete, since they are “deep” in their design, they can suffer a problem of so-called vanishing gradients. In order to address this issue, a Long Short Term Memory Network (LS™) can be employed. Such a variation of RNN was used in an example study. LS™ works even when there are long delays, unlike word-embeddings, where window size is fixed. LS™ can out-perform all other methods in language learning tasks. In one example, LSTMs were trained at a character level and word level for each description and were used to generate item snippets.

In an RNN-based extraction, a classification model was developed wherein summaries obtained from the base models were used for training a classifier. The sentences from the summaries were labeled as a positive class while the sentences which were not picked up and did not contain any of the topic signature words (or were of low score) were labeled as negative class.

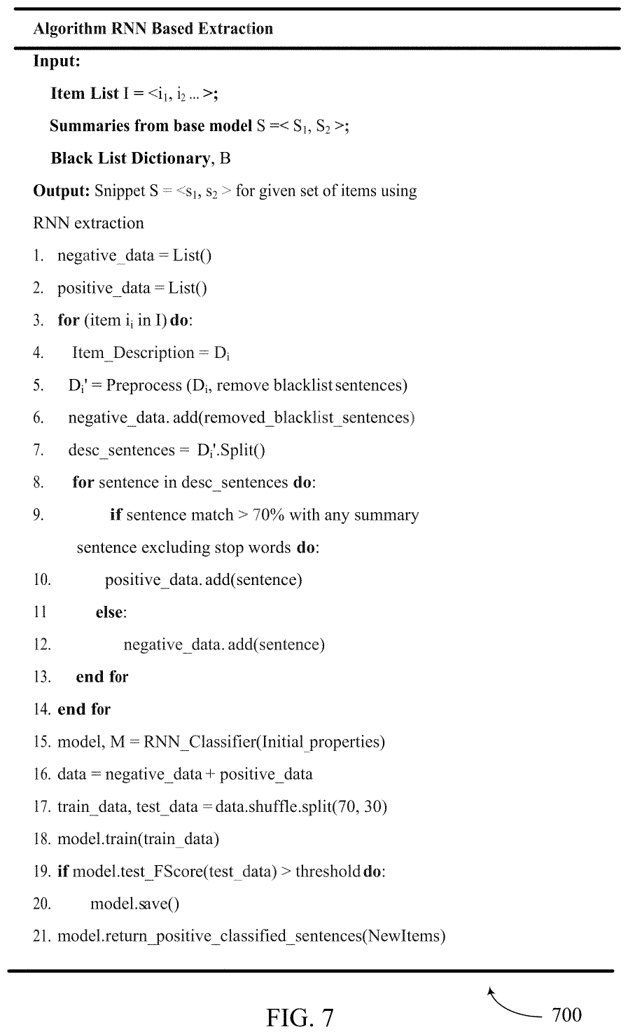

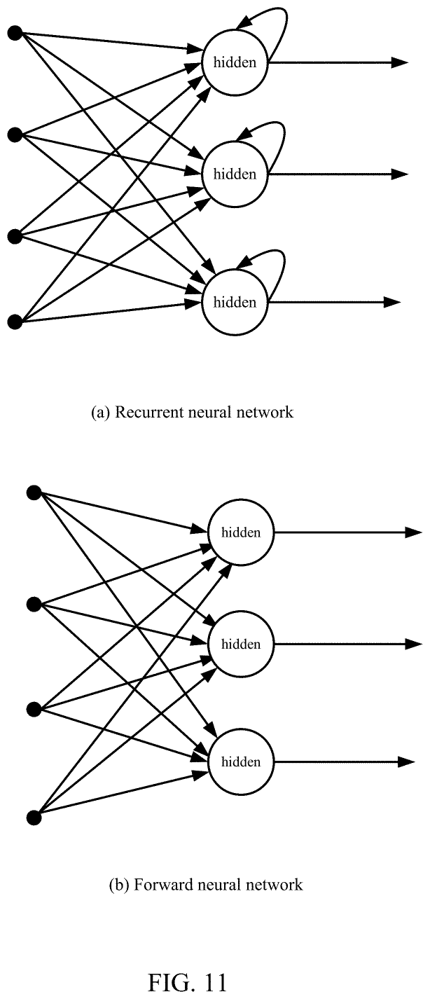

This approach can be considered analogous to a spam classifier in the sense that the characteristics of spam emails for most people can be somewhat similar. Spam can be predicted with a higher precision than non-spam because the non-spam emails for different people can be different, that is they are user-specific. In one study of the present disclosure, a similar concept was applied to build an RNN-based classifier. Item descriptions often contain seller-specific information, such as seller contact information, seller providing discount on their websites, seller seeking 5 star ratings, shipping information, and so forth. This kind of information is highly prevalent in e-commerce item descriptions yet is not needed in the item snippets; therefore it was hypothesized that it is easier to detect non-snippet information (which is somewhat similar for most items and is highly prevalent) with a higher precision than true item-related information (which is unique to each item and does not contain general information). The features used for building this example classifier included a position of the sentence in the description, word counts, tf-idf/word embedding based vectors. Other features are possible. FIG. 7 provides a detailed example RNN-based extraction algorithm 700 for RNN-based extraction. A more general flow diagram is given in FIG. 11.

RNN is a class of Neural Network which has a special structure as depicted in FIG. 11. While a conventional Feed Forward Neural Network passes data subsequently from one layer to another layer, in the case of RNN, connections between the units form a directed cycle, which helps in exhibiting dynamic temporal behavior and is useful when the underlying data has sequence characteristics such as text. In text or language applications, the appearance of a “next” word depends on the “previous” words mentioned in the conversation or written in the document. In simple words, while training RNN for classification, for example “Classifying a sentence as a summary/snippet sentence or not”, we pass the previous sentence or previous set of words that appeared along with the sentence itself. This helps in deciding whether a given sentence or a paragraph has a higher probability of being a summary sentence or not. For example, a sentence which has many previous bad sentences, i.e., the previous sentences were spam (for example), is more likely to also be spam. Descriptions on e-commerce sites such as eBay, for example, portray similar behavior: most of the spam sentences are grouped close to or proximate sentences such a seller's address and shipping information. This information, which is not needed in a good snippet, is grouped together while the sentences which are needed for a snippet, or good quality sentences, are grouped together. RNN leverages this approach to optimize snippet creation.

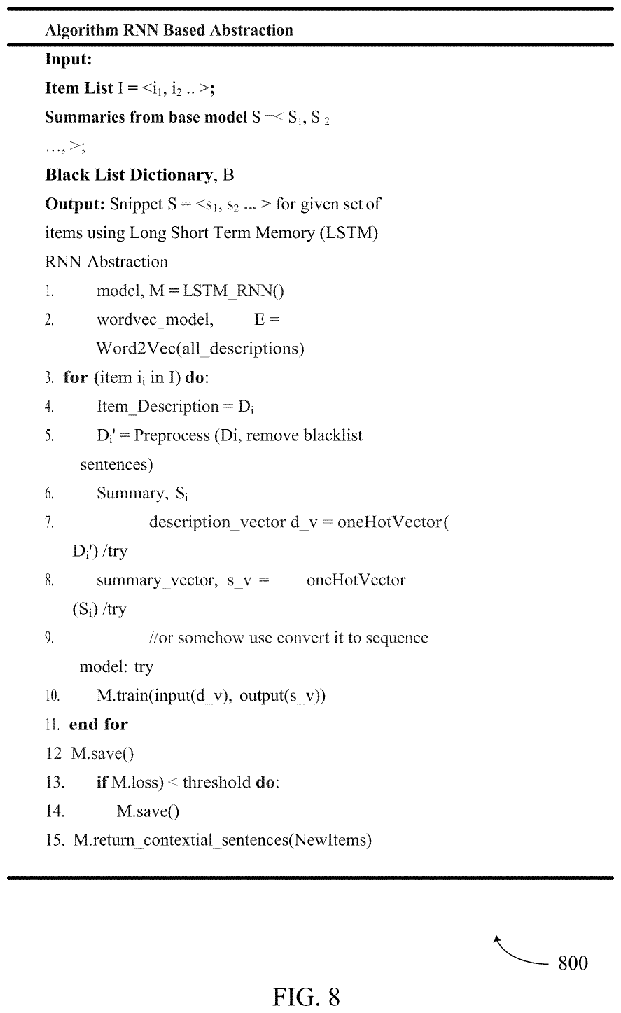

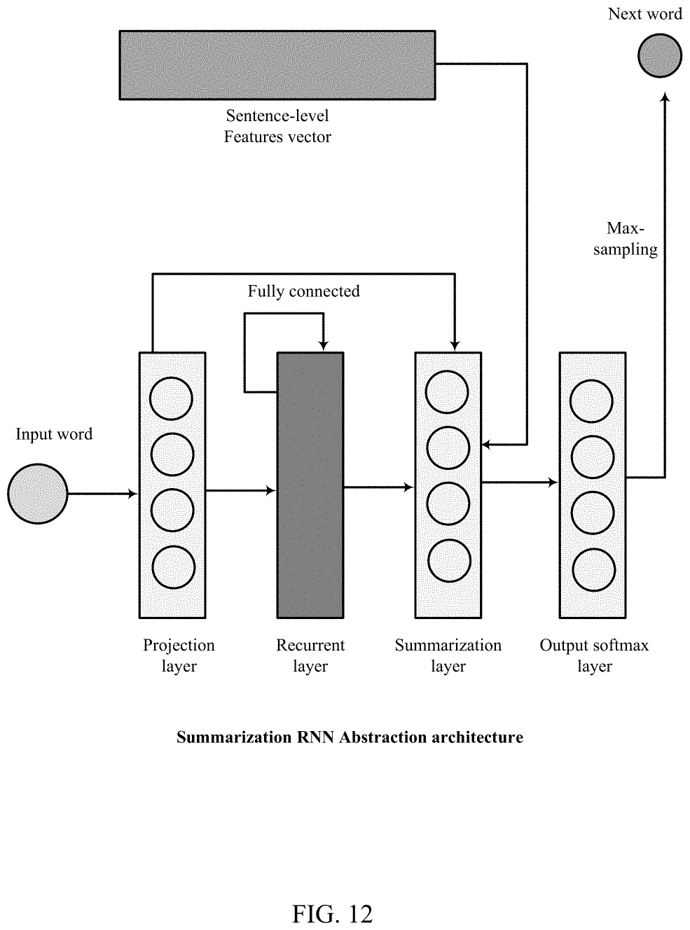

Turning now to RNN-based extraction, in this case a direct summary is fed as the output to the neural network corresponding to the entire description as input. Descriptions are pre-processed before performing the abstraction. One example compared and contrasted results before and after removing seller specific information as input, e.g., D vs. D′, or also trying removal of stop words. FIG. 8 depicts an example RNN-based abstraction algorithm 800. A more general flow diagram is shown in FIG. 12.

Architecture-wise, RNN-based abstraction is very similar to RNN-Extraction (also termed “RNN-E” herein). However, the objectives of the two approaches are different. RNN-E is a supervised algorithm, i.e., it needs training data as features and targets. For example, given a sentence with a label, such as summary sentence/non summary sentence, the model uses this information to learn what the characteristics are of a summary sentence and how the sentence is different from the characteristics and distribution of a non-summary sentence. This is how RNN-E classifies a summary or non-summary sentence.

On the other hand, RNN-Abstraction (also termed “RNN-A” herein) reads an entire item description and learns what to give out as a summary by observing the placement or appearance of characters and words by a technique called Sequence to Sequence Learning. The idea is to learn a sequence from a given sequence. So, the sequence of characters (which can be a sentence/snippet/summary) compared to another sequence of characters (which is a corresponding item description). RNN-A tries to map the description to corresponding snippets/summaries after learning the sequences or placements of characters/words.

An example base model evaluation and comparative analysis are now described.

2.1 Data Preparation

Approximately ten thousand items from different categories were sampled from active online item listings in a one-month sample period. Summaries corresponding to those items were generated using the snippet extractor described above. Furthermore, summaries for five hundred items from Electronics, Home & Garden, Motors, Fashion and Collectibles categories were re-sampled from the approximately ten thousand items. Human curated summaries were obtained for the five hundred items. As humans can generally exhibit certain personal biases, summaries obtained from different humans were expected to be different; therefore for each item, two copies from two different humans were obtained to reduce the effect of bias and increase study variance. This approach was also used to build the Summary Content Units (SCUs) for a “golden data” set.

Much supporting data is also needed for such analysis. Search queries were obtained corresponding to the approximately ten thousand items. In one example, category and sub-category names (catalogue or category tree) were leveraged as topic signatures for some of the summarization techniques. Item aspects information, which is a key-value pair of an aspect such as color, size, brand, condition, etc., was also used as topic signature information for each of the approximately ten thousand items. A Tf-idf score for each word from all the item descriptions (that is, the entire database of descriptions) was also generated which was used to know the relevance of each word. A dictionary of black-listed words and phrases was generated after analyzing eBay descriptions. This black list corresponded to frequently occurring seller specific information, shipping information, spam, pricing information, and so forth. As mentioned above, black-list information can be used to restrict or quickly detect sentences which are not needed in item snippets/summaries.

Thus, in one example study, there were two samples of data: (i) experimentation data and (ii) human curated “golden” set data, and three kinds of supporting data: (i) topic signature database (search queries, category tree, aspects information), (ii) tf-idf score for each word and (iii) black-list dictionary

2.2 Experiment Names

The following different experiments were conducted and are discussed in the subsequent sections: comparison of gold standards with base model, comparison of base model with original description, comparison of base model with extraction techniques (classification and IR), and a comparison of base model with abstraction and RNN extraction. A 10-fold cross validation for classification techniques, and a comparison of all extraction techniques, are also provided.

2.3 Evaluation Techniques

The following evaluation techniques were performed in the experiments: rogue and precision-recall, LSA and topic overlap using cosine, vector-based cosine similarity (such a Word2Vec, Glove, Doc2Vec, Tf-IDF, Normal with or without stop words), KL/JS divergence, largest common substring average, and summary probabilities.

2.4 Choosing the Base Models Using Gold-Standard Data

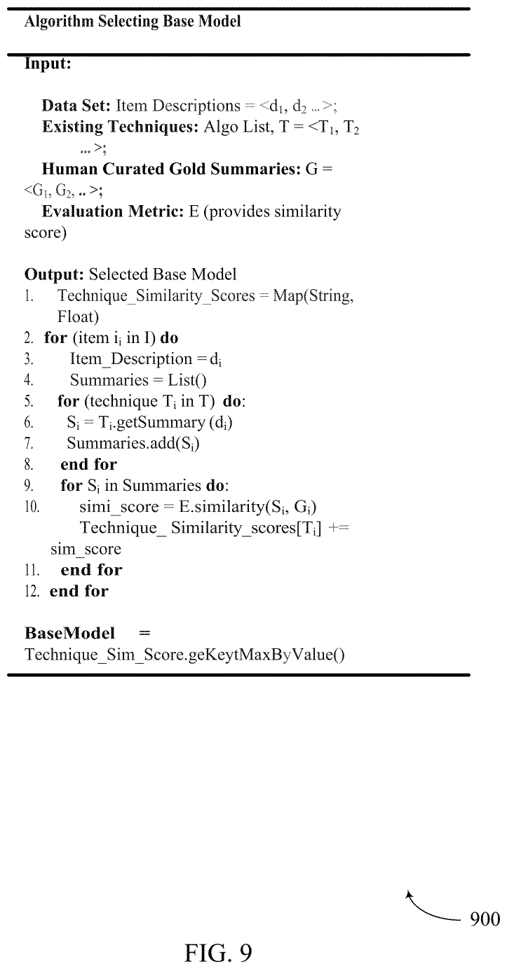

Results obtained from all the above mentioned approaches were compared against each other for selecting the base models. One of the chosen base models was the topic signature model. However, other models were also tried with the objective of performing detailed comparisons between various existing approaches. An example algorithm selecting optimum base model 900 is depicted in FIG. 9.

Table 1 provides the comparison of various models with respect to original descriptions. Table 2 provides the comparison with respect to Human Curated Golden Set. The model which “won” the evaluation tests depicted in Table 1 and 2 was considered the optimum base model.

The golden dataset is used for training the models. In one example it was shown that RNN is so powerful that even a small golden dataset can be used for training and still outperform other techniques. Industry-level evaluation and training is recommended, in some examples, for data quality. It was shown in some examples discussed below that RNN and other classification-based techniques are powerful enough to learn from the Topic Signature-based approach as well (even though the Topic Signature itself may not the best approach overall).

As discussed above, extensive experiments were performed on the golden dataset and large-scale data. Since the golden dataset is the ground truth, so to speak, the tables presented below represent the best base line for our study. Furthermore, evaluation on the golden dataset also helped in assessing the performance of the Topic Signature approach, which was initially considered as the base model and is in commercial production at some publication systems (e.g., publication system 106).

For an example golden dataset, outputs from various algorithms were obtained and used for analysis on various metrics. Table 1 below provides the results regarding the same:

TABLE 1
Result of models on gold dataset

| Evaluation | Topic | | | | RNN | | Naïve |
|---|---|---|---|---|---|---|---|
| Metric | Signature | LSA | LexRank | TextRank | Extraction | SVM | Bayes |
| Token Similarity | 0.13 | 0.11 | 0.09 | 0.08 | 0.13 | 0.10 | 0.16 |
| Tf-IDF | 0.56 | 0.46 | 0.38 | 0.32 | 0.47 | 0.37 | 0.50 |
| Rouge-1 | 0.35 | 0.28 | 0.17 | 0.18 | 0.33 | 0.17 | 0.29 |
| Rouge-2 | 0.54 | 0.41 | 0.17 | 0.26 | 0.40 | 0.20 | 0.41 |
| Rouge-LCS | 0.4 | 0.37 | 0.44 | 0.35 | 0.44 | 0.44 | 0.36 |
| Topic Similarity | 0.12 | 0.11 | 0.07 | 0.06 | 0.13 | 0.05 | 0.08 |
| KL Divergence | 0.07 | 0.08 | 0.12 | 0.03 | 0.1 | 0.41 | 0.22 |

It can be seen in Table 1 that Topic Signature and RNN extraction (RNN-E) outperformed all other techniques on the golden dataset. Both RNN and Topic Signature were the best on four out of eight comparison metrics. It is to be noted that even though RNN was not explicitly trained on topic words, unlike the Topic Signature algorithm, RNN-Extraction performed better than Topic Signature in topic similarity. The reason for this is considered to be that in the case of Topic Signature, paragraphs or sentences around the topic words were considered as the summary; however, several important sentences with more topic words might exist in other paragraphs or may be spread out across the entire document, which might be missed in case of the Topic Signature approach. However, the RNN approach on the other hand finds the most important sentences and identifies or extracts them in a snippet (summary), hence leading to a greater number of topic sentences.

It is to be noted that while the Topic Signature approach may currently be implemented in production in some applications, it is observed that it does not generalize well, i.e., it does not capture the local or seasonal or other context-driven edge cases. RNN, on the other hand, generalizes well based on a given context. Hence, RNN can also be used to summarize reviews, products, seasons and even improved personalization of snippet creation.

In one example, an extraction score (Escore) metric was created to explore these factors:
Test data: User sessions coming from SRP with Search “INCLUDE DESCRIPTION”

$$Escore = \frac{\begin{matrix}\# search queries present in \\ the snippet leading to engagement\end{matrix} }{\# search queries leading to engagement}$$

$$E score of RNN = 111 \% of E score of Topic Signature$$

What this extraction score implies is that given a snippet created from RNN and Topic Signature approaches, the RNN-based snippet covers a greater number of search queries that are not in the title, but in the item description itself. One commercial example search page has the option of “include descriptions” in the search navigation bar which tries to find the user queries in the item description as well apart from the title itself. RNN-based snippets capture such queries better than Topic Signature not only in topic similarity (title, category words) as shown in Table 1, but also from other information lifted from the item descriptions used in the experiment. Therefore, RNN in this example created a better snippet (i.e., attracting more queries) based on topics than the Topic Signature approach itself.

Table 2 below shows the performance of various models trained on a human-generated golden dataset. In the case of machine learning (ML)-based models (RNN, NB and SVM), the models were trained on 80% of the golden dataset and the testing was performed on the 20% remaining data. For the non-machine learning models, the same 20% test data was used to obtain corresponding metrics. All the comparisons in Table 2 were performed on the same 20% test data.

An F-score or F1-score is a measure of test accuracy. This measure considers both precision and recall. It gives an overall performance of the model, giving equal weights to precision and recall. It is a harmonic mean of precision and recall. If a model trained on unbalanced data has high recall but very bad precision, then it is a poor model since it will tend to classify everything as one class, in the case of binary classification, hence leading to a poor F1-score overall. An F1-score also provides an indication of the consistency of the model.

TABLE 2
Model Performance (Classes: Non-summary, Summary)

| Model | Accuracy | Precision | Recall | F1-score |
|---|---|---|---|---|
| Topic Signature | 0.55 | 0.63, 0.51 | 0.37, 0.76 | 0.46, 0.61 |
| LSA | 0.49 | 0.48, 0.50 | 0.67, 0.32 | 0.56, 0.39 |
| RNN | 0.97 | 0.99, 0.74 | 0.98, 0.75 | 0.98, 0.75 |
| Naïve Bayes | 0.95 | 0.99, 0.57 | 0.96, 0.85 | 0.97, 0.68 |
| SVM | 0.97 | 0.97, 0.85 | 0.99, 0.56 | 0.98, 0.68 |

It will be observed from Table 2 that the RNN extraction approach yielded the highest F-score, precision, and recall numbers. Topic Signature, on the other hand, produced results that are among the two poorest performances.

The RNN-based snippet extraction approach outperformed all the tested models not only in terms of precision, recall, f-score metrics (i.e., by most standard baselines), but also in other metrics which relate to the quality of the snippet itself. RNN performed significantly better than the Topic Signature and LSA-based approaches, which are industry standards used by various news, media, social and e-commerce websites today. RNN also generalized well compared to other methods as it can capture seasonality, locality, and context aspects.

What is claimed is:

1. A computer implemented method comprising:
receiving one or more product descriptions describing a product;
developing, by at least one processor, a classification model using Recurrent Neural Network (RNN) extraction based at least in part on the one or more product descriptions;
generating, by the at least one processor, a snippet of a product description of the one or more product descriptions based at least in part on the classification model; and
causing presentation of the snippet of the product description based at least in part on the generating.

2. The method of claim 1, further comprising:
receiving a search query mapped to the product, wherein causing the presentation of the snippet of the product description is in response to receiving the search query.

3. The method of claim 1, wherein receiving the one or more product descriptions comprises:
receiving the one or more product descriptions comprising seller-specific information associated with the product.

4. The method of claim 3, wherein generating the snippet of the product description further comprises:
generating the snippet of the product description that excludes the seller-specific information.

5. The method of claim 1, wherein receiving the one or more product descriptions comprises:
receiving the one or more product descriptions comprising product-specific information associated with the product.

6. The method of claim 5, wherein generating the snippet of the product description further comprises:
generating the snippet of the product description that includes the product-specific information.

7. The method of claim 1, wherein generating the snippet further comprises:
determining that at least one word of the one or more product descriptions is included in a predefined list of words; and
generating the snippet of the product description that excludes the at least one word included in the predefined list of words.

8. A system, comprising:
at least one processor; and
a memory device storing instructions that, when executed by the at least one processor, cause the system to perform operations comprising:
receiving one or more product descriptions describing a product;
developing, by at least one processor, a classification model using Recurrent Neural Network (RNN) extraction based at least in part on the one or more product descriptions;
generating, by the at least one processor, a snippet of a product description of the one or more product descriptions based at least in part on the classification model; and
causing presentation of the snippet of the product description based at least in part on the generating.

9. The system of claim 8, wherein the instructions are further executable to perform operations comprising:
receiving a search query mapped to the product, wherein causing the presentation of the snippet of the product description is in response to receiving the search query.

10. The system of claim 8, wherein the instructions are further executable to perform operations comprising:
receiving the one or more product descriptions comprising seller-specific information associated with the product.

11. The system of claim 10, wherein the instructions for generating the snippet are executable to perform operations comprising:
generating the snippet of the product description that excludes the seller-specific information.

12. The system of claim 8, wherein the instructions are further executable to perform operations comprising:
receiving the one or more product descriptions comprising product-specific information associated with the product.

13. The system of claim 12, wherein the instructions for generating the snippet are executable to perform operations comprising:
generating the snippet of the product description that includes the product-specific information.

14. The system of claim 8, wherein the instructions for generating the snippet are executable to perform operations comprising:
determining that at least one word of the one or more product descriptions is included in a predefined list of words; and
generating the snippet of the product description that excludes the at least one word included in the predefined list of words.

15. A non-transitory computer-readable medium comprising instructions that, when executed, cause a machine to perform operations comprising:
receiving one or more product descriptions describing a product;
developing, by at least one processor, a classification model using Recurrent Neural Network (RNN) extraction based at least in part on the one or more product descriptions;
generating, by the at least one processor, a snippet of a product description of the one or more product descriptions based at least in part on the classification model; and
causing presentation of the snippet of the product description based at least in part on the generating.

16. The non-transitory computer-readable medium of claim 15, wherein the instructions are further executable to perform operations comprising:
receiving a search query mapped to the product, wherein causing the presentation of the snippet of the product description is in response to receiving the search query.

17. The non-transitory computer-readable medium of claim 15, wherein the instructions are further executable to perform operations comprising:
receiving the one or more product descriptions comprising seller-specific information associated with the product.

18. The non-transitory computer-readable medium of claim 17, wherein the instructions for generating the snippet are executable to perform operations comprising:
generating the snippet of the product description that excludes the seller-specific information.

19. The non-transitory computer-readable medium of claim 15, wherein the instructions are further executable to perform operations comprising:
receiving the one or more product descriptions comprising product-specific information associated with the product.

20. The non-transitory computer-readable medium of claim 19, wherein the instructions for generating the snippet are executable to perform operations comprising:
generating the snippet of the product description that includes the product-specific information.
